(19) United States
(12) Patent Application Publication
(10) Pub. No.: US 2006/0088183 A1
(43) Pub. Date: Apr. 27, 2006

(54) Speaker apparatus

(75) Inventors: Koji Takayama, Yamagata (JP); Shinichi Hayasaka, Yamagata (JP); Kazuki Yuze, Yamagata (JP)

Correspondence Address: SUGHRUE MION, PLLC, 2100 PENNSYLVANIA AVENUE, N.W., SUITE 800, WASHINGTON, DC, 20037, US

(73) Assignees: PIONEER CORPORATION; TOHOKU PIONEER CORPORATION

(21) Appl. No.: 11/259,083

(22) Filed: Oct. 27, 2005

(30) Foreign Application Priority Data
Oct. 27, 2004 (JP) P2004-312725

(51) Int. Cl. H04R 9/06; H04R 11/02

(52) U.S. Cl. 381/398; 381/412

(57) ABSTRACT

An outer circumferential portion of a speaker frame on which an edge overlap width portion of an edge portion around the outer circumference of a diaphragm has a taper portion overhanging obliquely forward from the speaker attaching opening diameter d1, an edge attachment portion extending from the outer circumference of the taper portion in a direction orthogonal to a central axis of the speaker, and a mounting plate contact portion extending from the outer circumference of the edge attachment portion to the speaker mounting plate, with a distal end contacting the speaker mounting plate. A resin packing carrying the edge overlap width portion with the edge attachment portion is provided.

### BACKGROUND OF THE INVENTION

1. Field of the Invention

The present invention relates to a speaker apparatus in which an edge overlap width portion around the outer circumference of a diaphragm is pasted on an outer circumferential portion of a speaker frame.

2. Description of the Related Art

FIG. 1 is a longitudinal cross-sectional view of the conventional speaker apparatus.

This speaker apparatus 1 includes a magnetic circuit 3, a speaker frame 5 in which the magnetic circuit 3 is mounted on its rear portion, a cone-type diaphragm 7 in which an edge 9 having a roll-like section is linked to an outer circumference, a cylindrical voice coil bobbin 11 mounted on an inner edge of the diaphragm 7, and a voice coil 12 wound around the voice coil bobbin 11.

The magnetic circuit 3 includes a yoke 15 having a structure in which a cylindrical center pole 15b protrudes in the center of a disk-like plate 15a, a ring-like magnet 16 fitted loosely around the outer circumference of the center pole 15b, and a ring-like top plate 17 fitted loosely at the distal end of the center pole 15b to carry the magnet 16 with the plate 15a. The top plate 17 is fixed to the rear end of the speaker frame 5.

In this magnetic circuit 3, a magnetic gap for arranging the voice coil 12 lies between the inner circumference of the top plate 17 and the center pole 15b.

The voice coil bobbin 11 fixed to the inner edge of the diaphragm 7 is connected via a bellows-like corrugate damper 19 to the speaker frame 5, and suspended movably in the axial direction of the center pole 15b.

The edge 9 around the outer circumference of the diaphragm 7 supports the diaphragm 7 amplifiably, because an edge overlap width portion 9a extending on its outer edge is pasted onto the outer circumferential portion 5a of the speaker frame 5.

Up to now the outer circumferential portion 5a of the speaker frame 5 includes an edge attachment portion 23 extending outward along the surface of a speaker mounting plate 21 from the margin of the speaker attaching opening diameter d1 of the speaker mounting plate 21, and an auxiliary marginal portion 24 stood forward from the outer circumference of the edge attachment portion 23, in which the edge 9 is pasted on the surface of the edge attachment portion 23 (e.g., refer to JP-A-2000-261886).

### SUMMARY OF THE INVENTION

To enhance the output sound pressure in the speaker apparatus and the reproduction characteristics of low range, it is effective to increase the diaphragm area by making the effective diameter D1 of the diaphragm 7 larger.

However, in a mounting structure of the diaphragm 7 as shown in FIG. 1, the effective diameter D1 of the diaphragm 7 is equal to the value of subtracting the roll width W1 of the edge 9 from the speaker attaching opening diameter d1 of the speaker mounting plate 21 (i.e., D1=d1−W1), whereby the effective diameter D1 of the diaphragm 7 can not be increased unless the position of the edge 9 is shifted radially outward.

However, in the speaker apparatus installed on the vehicle, the speaker attaching opening diameter d1 and the maximum diameter D2 of the outer circumferential portion 5a are often regulated, because of a limited installation space on the vehicle.

In this situation where the speaker attaching opening diameter d1 and the maximum diameter D2 of the outer circumferential portion 5a can not be increased, if the position of the edge 9 is shifted radially outward, the mounting structure is such that an end of the roll portion of the edge 9 is stranded on the edge attachment portion 23 of the speaker frame 5, as shown in FIG. 2. For example, there was a risk that a part of the roll portion contacts the edge attachment portion 23 to impair the amplitude operation of the diaphragm 7, when the diaphragm 7 is in the lower amplitude. Practically, there was a problem that the diaphragm area could not be increased by changing the position of the edge 9.

Also, in a mounting structure in which the position of the edge 9 is shifted radially outward without retrofitting the outer circumferential portion 5a of the speaker frame 5, as shown in FIG. 2, there was a problem that the overlap width T1 of the edge 9 pasted on the edge attachment portion 23 is narrower, whereby it is difficult to secure a sufficient bonding strength between the edge 9 and the edge attachment portion 23.

It is an object of the invention to provide a speaker apparatus in which the output sound pressure and the reproduction characteristics of low range are improved by enlarging the effective diameter of the diaphragm and increasing the diaphragm area in a situation where the speaker attaching opening diameter and the maximum diameter of the outer circumferential portion of the frame are determined. Further, it is another object of the invention to provide a speaker apparatus in which the frame claw portions equipped to allow a certain latitude in the pitch circle diameter in a portion screwed with the speaker mounting plate can be simply excised, if they interfere, and there is no inconvenience that the extended measures for the mounted vehicle due to the frame claw portions 53 equipped have conversely some restraints on the mounted vehicle.

According to an aspect of the invention, there is provide with a speaker apparatus including: a speaker frame having an outer circumferential portion extending outside a position where the speaker mounting plate has the opening diameter for attaching a speaker; and a diaphragm having an edge overlap width portion around an outer circumference thereof. The outer circumferential portion of the speaker frame is configured by a taper portion, an edge attachment portion, and a mounting plate contact portion. The taper portion overhangs obliquely forward from the position where the speaker mounting plate has the opening diameter for attaching the speaker. The edge attachment portion extends from the outer circumference of the taper portion in a direction orthogonal to a speaker central axis. A surface of the edge attachment portion is an edge mounting face on which the edge overlap width portion is attached. The mounting plate contact portion extends from the outer circumference of the edge attachment portion to the speaker mounting plate, with a distal end contacting the speaker mounting plate. A resin packing is fixed to the outer circumferential portion of the speaker frame in a state where the edge overlap width portion is carried with the edge attachment portion.

According to another aspect of the invention, there is provided with a speaker apparatus including: a diaphragm having an edge overlap width portion around an outer circumference thereof; a speaker frame having an outer circumferential portion extending outside a position where the speaker mounting plate has the speaker opening diameter for attaching the speaker, wherein the edge overlap width portion is attached to an outer circumferential portion of a speaker frame. A resin packing is fixed to the outer circumferential portion of the speaker frame in a state where the edge overlap width portion is carried with the edge attachment portion. A resin packing is fixed to the outer circumferential portion of the speaker frame in a state where the edge overlap width portion is carried with the outer circumferential portion of the speaker frame. A threaded portion is formed around the outer circumferential portion of the speaker frame and in the resin packing so as to screw the speaker apparatus with the speaker mounting plate. The threaded portion has a pair of frame claw portions for screwing that are formed in the resin packing. The pair of frame claw portions project outward from an outer edge of the speaker frame. The pair of frame claw portions have an auxiliary groove for cutting a range projecting from an outer edge of the speaker frame at a position corresponding to the outer edge of the speaker frame.

### BRIEF DESCRIPTION OF THE DRAWINGS

FIG. 1 is a longitudinal cross-sectional view of the speaker apparatus according to a related art.

FIG. 2 is a cross-sectional view of an outer circumferential portion of a speaker frame when an edge overlap width position is shifted outward in the speaker apparatus of FIG. 1.

FIG. 3 is a front view of a speaker apparatus according to an embodiment.

FIG. 4 is a cross-sectional view of the speaker apparatus as shown in FIG. 3, taken along the line IV-IV.

FIG. 5 is an enlarged partial cross-sectional view of FIG. 3, taken along the line V-V.

FIG. 6 is an enlarged partial cross-sectional view of FIG. 3, taken along the line VI-VI.

FIG. 7 is a cross-sectional view of FIG. 3, taken along the line VII-VII.

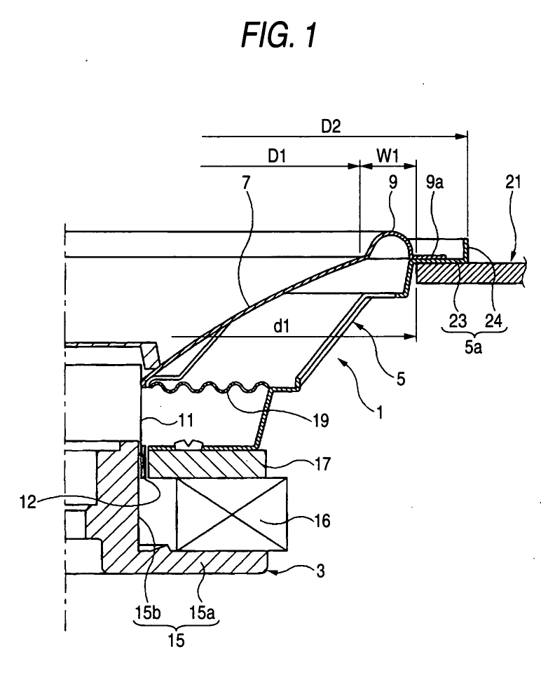

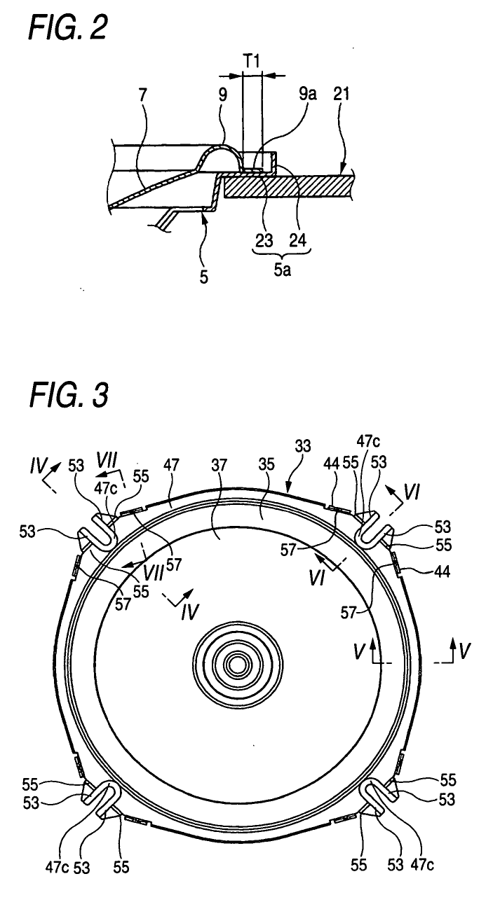

### DESCRIPTION OF THE PREFERRED EMBODIMENTS

An embodiment of the present invention will be described below in detail with reference to the accompanying drawings.

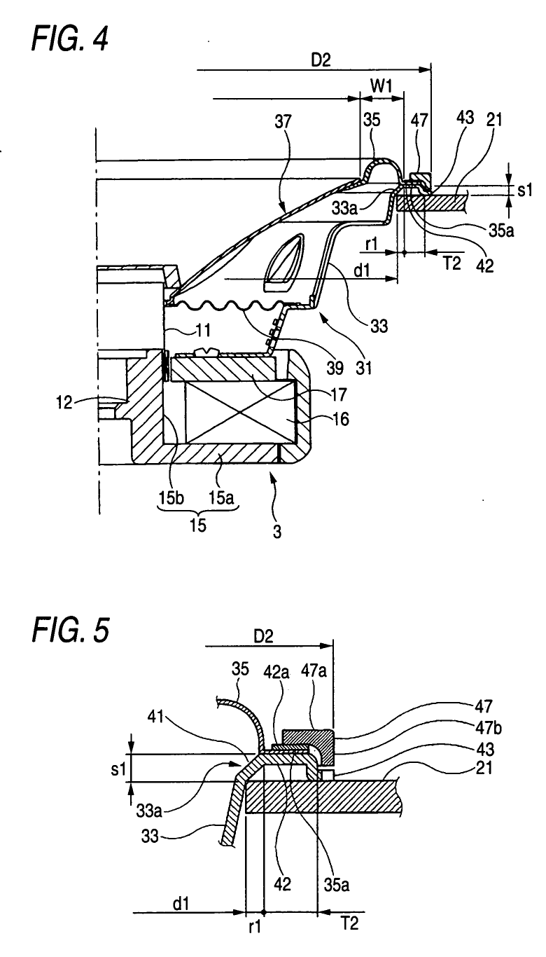

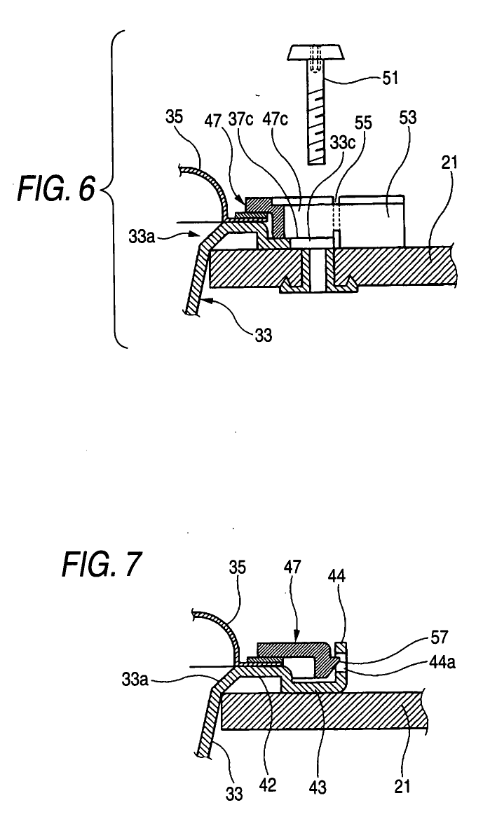

FIGS. 3 to 7 show a speaker apparatus according to the embodiment. FIG. 3 is a front view of a speaker apparatus according to the embodiment. FIG. 4 is a cross-sectional view of the speaker apparatus as shown in FIG. 3, taken along the line IV-IV. FIG. 5 is an enlarged partial cross-sectional view of FIG. 3, taken along the line V-V. FIG. 6 is an enlarged partial cross-sectional view of FIG. 3, taken along the line VI-VI. FIG. 7 is a cross-sectional view of FIG. 3, taken along the line VII-VII.

The speaker apparatus 31 has a magnetic circuit 3, a speaker frame 33 in which the magnetic circuit 3 is mounted on its rear portion, a cone-type diaphragm 37 in which an edge 35 having a roll-like section is linked to an outer circumference, a cylindrical voice coil bobbin 11 mounted on an inner edge of the diaphragm 37, and a voice coil 12 wound around the voice coil bobbin 11.

The magnetic circuit 3 includes a yoke 15 having a structure in which a cylindrical center pole 15b protrudes in the center of a disk-like plate 15a, a ring-like magnet 16 fitted loosely around the outer circumference of the center pole 15b, and a ring-like top plate 17 fitted loosely at the distal end of the center pole 15b to carry the magnet 16 with the plate 15a. The top plate 17 is fixed to a rear end of the speaker frame 33.

In this magnetic circuit 3, a magnetic gap for arranging the voice coil 12 lies between the inner circumference of the top plate 17 and the center pole 15b.

The voice coil bobbin 11 fixed to the inner edge of the diaphragm 37 is connected via a bellows-like corrugate damper 39 to the speaker frame 33, and suspended movably in the axial direction of the center pole 15b.

The edge portion 35 around the outer circumference of the diaphragm 7 supports the diaphragm 37 amplifiably, because an edge overlap width portion 35a extending on its outer edge is pasted onto the outer circumferential portion 33a of the speaker frame 33 extending outside the speaker attaching opening diameter d1 of the speaker mounting plate 21.

The outer circumferential portion 33a of the speaker frame 33 includes a taper portion 41 overhanging obliquely forward from the fore edge portion of the speaker attaching opening diameter d1 in the speaker mounting plate 21, an edge attachment portion 42 extending from the outer circumference of the taper portion 41 in a direction orthogonal to a central axis of the speaker, and a mounting plate contact portion 43 extending from the outer circumference of the edge attachment portion 42 to the speaker mounting plate 21, with a distal end contacting the speaker mounting plate 21, as shown in FIG. 5.

The front end of the taper portion 41 is spaced in a direction of greater diameter by distance r1 from the position of the speaker attaching opening diameter d1, and spaced forward by distance s1 from a mounting face of the speaker mounting plate 21, as shown in FIG. 3.

The surface of the edge attachment portion 42 is an edge mounting face 42a for pasting the edge overlap width portion 35a. The width size T2 in a radial direction of the edge mounting face 42a becomes an edge overlap width.

In the speaker apparatus 31 of the embodiment, a resin packing (resin packing portion) 47 fixed to the outer circumferential portion 33a of the speaker frame 33 in a state where the edge overlap width portion 35a is carried with the edge attachment portion 42 is provided.

The resin packing 47 has an upper wall portion 47a for pressing the edge overlap width portion 35a against the edge attachment portion 42 and a side wall portion 47b suspended from the outer circumference of the upper wall portion 47a to the mounting plate contact portion 43, and has a cross section like L-shaped all around the circumference, as shown in FIG. 5.

Also, to screw the speaker apparatus 31 with the speaker mounting plate 21, the outer circumferential portion 33a of the speaker frame 33 and the resin packing 47 are formed with the threaded portions 33c and 47c in four portions around the outer circumference, as shown in FIG. 3.

These threaded portions 33c and 47c are formed with a notch like U-shaped in plan view to insert a screw member 51 (see FIG. 6).

In the case of the threaded portions 47c of the resin packing 47, one pair of frame claw portions 53 that form a notch like U-shaped in plan view project outward from the outer edge of the speaker frame 33, as shown in FIGS. 3 and 6.

Further, in the embodiment, one pair of frame claw portions 53 in the resin packing 47 is provided with an auxiliary groove 55 for facilitating the excision of a range protruding from the outer edge of the speaker frame 33 at a position corresponding to the outer edge of the speaker frame 33, as shown in FIGS. 3 and 6. This auxiliary groove 55 is equipped on an upper face, an outer side face and a lower face of each frame claw portion 53, as shown in FIG. 6.

In the embodiment, an engagement portion 57 engaged in the speaker frame 33 is provided at a position near each threaded portion 47c on the outer circumferential portion of the resin packing 47.

The engagement portion 57 is a projection projecting radially outward from the diaphragm 37, as shown in FIG. 7. The mounting plate contact portion 43 on the outer circumferential portion 33a of the speaker frame 33 is linked to an engaging piece (an engaging portion) 44 rising at a position opposed to the engagement portion 57, which is fitted into an engagement hole 44a formed in this engaging piece 44, so that the resin packing 47 is fixed not to float from the mounting plate contact portion 43.

The engagement portion 57 and the engaging piece 44 are provided each one at both sides of every threaded portion 47c, and provided at a total of 8 positions all around the outer circumference of the resin packing 47 and the speaker frame 33.

As detailed above, in the speaker apparatus 31 according to the embodiment, the taper portion 41 is provided on the outer circumferential portion 33a of the speaker frame 33, the width of the edge attachment portion 42 occupied in the outer circumferential portion 33a of the speaker frame 33 is narrower by the radial size r1 of the taper portion 41 in a situation where the speaker attaching opening diameter d1 and the maximum diameter D2 of the frame outer circumferential portion are determined. As a result, the edge overlap width portion 35a of the edge 35 is narrower.

However, the effective diameter of the diaphragm 37 can be enlarged by 2×r1 by shifting the position of the edge 35 radially outward.

And since the edge overlap width portion 35a of the edge 35 is narrower, the bonding strength with the speaker frame 33 due to the edge overlap width portion 35a of the edge 35 is weaker. However, since the resin packing 47 that carries the edge overlap width portion 35a of the edge 35 with the edge attachment portion 42 of the speaker frame 33 reinforces the bonding strength, the sufficient bonding strength can be actually fixed between the edge 35 and the speaker frame 33.

Also, the taper portion 41 provided on the outer circumferential portion 33a of the speaker frame 33 serves as an escape to avoid interference with the roll portion when the diaphragm 37 is in the lower amplitude, and the mounting position of the diaphragm 37 is shifted forward by the size s1 by the taper portion 41, whereby there is no risk that the amplitude operation of the diaphragm 37 is impaired.

Accordingly, the output sound pressure and the reproduction characteristics of low range can be improved by enlarging the effective diameter of the diaphragm 37 and increasing the area of the diaphragm 37.

In the speaker apparatus 31, the frame claw portions 53 equipped to allow a certain latitude in the pitch circle diameter of the threaded portion with the speaker mounting plate 21 can be simply excised, if they interfere, because the frame claw portion is a part of the resin packing 47, and the auxiliary groove 55 is provided to facilitate the excision at a position corresponding to the outer edge of the speaker frame 33 on the frame claw portions 53. Thereby, when the frame claw portion 53 is in the way, it is possible to remove it and there is no inconvenience that the extended measures for the mounted vehicle due to the frame claw portions 53 equipped have conversely some restraints on the mounted vehicle.

In the speaker apparatus 31, the engagement portion 57 equipped at the position near the threaded portion 47c having the frame claw portion 53 is fixed with the engaging piece 44 of the speaker frame 33, whereby in cutting off the frame claw portions 53, even if a bending force is exerted in a direction of peeling the resin packing 47 from the outer circumferential portion 33a of the speaker frame 33, there is no inconvenience that the cutting process of the frame claw portions 53 causes exfoliation of the resin packing 47.

The features of the speaker apparatus according to the embodiment are especially beneficial for the speaker apparatus mounted on the vehicle having some constraints such as a mounting space, but may be applicable to the speaker apparatus mounted on the portable telephone or portable audio equipment, other than the vehicle.

What is claimed is:

1. A speaker apparatus comprising:
a speaker frame having an outer circumferential portion extending outside a position where the speaker mounting plate has the opening diameter for attaching a speaker; and
a diaphragm having an edge overlap width portion around an outer circumference thereof,
wherein the outer circumferential portion of the speaker frame is configured by a taper portion, an edge attachment portion, and a mounting plate contact portion,
wherein the taper portion overhangs obliquely forward from the position where a speaker mounting plate has an opening diameter for attaching the speaker apparatus,
wherein the edge attachment portion extends from the outer circumference of the taper portion in a direction orthogonal to a speaker central axis,
wherein a surface of the edge attachment portion is an edge mounting face on which the edge overlap width portion is attached,
wherein the mounting plate contact portion extends from the outer circumference of the edge attachment portion to the speaker mounting plate, with a distal end contacting the speaker mounting plate, and
wherein a resin packing is fixed to the outer circumferential portion of the speaker frame in a state where the edge overlap width portion is carried with the edge attachment portion.

2. A speaker apparatus comprising:
a diaphragm having an edge overlap width portion around an outer circumference thereof;
a speaker mounting plate having a speaker opening diameter for attaching a speaker; and
a speaker frame having an outer circumferential portion extending outside a position where the speaker mounting plate has the speaker opening diameter for attaching the speaker,
wherein the edge overlap width portion is attached to an outer circumferential portion of a speaker frame,
wherein a resin packing is fixed to the outer circumferential portion of the speaker frame in a state where the edge overlap width portion is carried with the edge attachment portion.
wherein a resin packing is fixed to the outer circumferential portion of the speaker frame in a state where the edge overlap width portion is carried with the outer circumferential portion of the speaker frame,
wherein a threaded portion is formed around the outer circumferential portion of the speaker frame and in the resin packing so as to screw the speaker apparatus with the speaker mounting plate,
wherein the threaded portion has a pair of frame claw portions for screwing that are formed in the resin packing,
wherein the pair of frame claw portions project outward from an outer edge of the speaker frame, and
wherein the pair of frame claw portions have an auxiliary groove for cutting a range projecting from an outer edge of the speaker frame at a position corresponding to the outer edge of the speaker frame.

3. The speaker apparatus according to claim 2, wherein an engagement portion engageable with the speaker frame is provided at a position near the threaded portion on the outer circumferential portion of the resin packing.
